(19) United States
(12) Patent Application Publication
(10) Pub. No.: US 2009/0306560 A1
(43) Pub. Date: Dec. 10, 2009

(54) Massage implement

(76) Inventor: Merrill A. Lund, Bonita Springs, FL (US)

Correspondence Address: Merrill A. Lund, 1044 Castello Rd. #213, Naples, FL, 34103, US

(21) Appl. No.: 12/156,841

(22) Filed: Jun. 6, 2008

(51) Int. Cl. A61H 7/00

(52) U.S. Cl. 601/135; 601/134; 601/136

(57) ABSTRACT

A massage implement consisting of two elements. One element is a metal tube that receives an adjustable insert therein. The insert and the tube are adjustable in length relative to each other. The metal tube has at its top a T-shaped configuration attached thereto which is made of a hard rubber or plastic material. The sliding insert is made of hard rubber or a plastic material and has a way of arresting the sliding insert therein after a predetermined length has been established. The sliding insert has at its bottom replaceable massaging tools thereon. The different massaging tools are used for treating different areas on the body of a patient. The massage implement is used by a therapist by placing the T-shaped configuration in the area of the armpit and by applying pressure to any of the bottom massage tools. The pressure is applied by the weight of the body of therapist.

### FIELD OF THE INVENTION

The inventive implement relates to,an implement or a tool that is being used while given a massage to a person.

### BACKGROUND OF THE INVENTION

There are many massage therapists, and most of them love their work, and many of them are highly educated and extremely effective at alleviating or removing pain syndromes.

The problem is that in order to do deep effective work in a body massage takes a huge toll on the therapists bodies, especially their thumbs, wrists and/or arms. This problem may lead to most therapists' use so many less effective treatment on their patients.

More neuromuscular type treatments are much more effective but require a on part of the therapist great physical effort, while may times causing injuries to the care giver. The biggest reason that massage therapists leave the profession, after a few year, is because of injury, wear and tear on their bodies. There are many tools available on the market to aid the therapists making the task of given a massage much easier on their body. The only tools currently available use hand, wrist or weight to apply therapeutic pressure.

U.S. Pat. No. 6,267,738 is an example of such a tool. The tool has more or less pointed ends that are applied to the soft tissue of a patient by the application of pressure. The drawbacks of such a tool is that it uses its own weight to apply pressure and the therapists must use the hands, wrists or arms to hold the 8 lb. weight and guide it. The risk of dropping the tool on a patient is a concern as well.

U.S. Pat. No. 4,648,387 is another tool comprising a multiple of rollers mounted on an elongated cylindrical shaft having a handle at each end. The rollers have a plurality of pressure pads disposed in annular rows. The tool is used to apply pressures to various parts of the body.

U.S. Pat. No. 5,577,995 discloses a therapeutic tool which is used to mobilize the spinal joints and soft tissues surrounding the human spine. The device includes two substantially solid balls mounted on a shaft and spaced from each other. By rolling the balls on the back of a patient the balls result in a therapeutic treatment.

### BRIEF DESCRIPTION OF THE INVENTION

The inventive massage implement I designed to apply varying amounts of pressure to the body of a patient without putting undue pressure on the arms, wrists or thumbs of the therapist while the therapist's hands can both remain gently touching the patient, sensing problem areas and bony protuberances and guiding their body's pressure where desired.

An object of the tool or implement alleviate any undue pressures on the arms, wrists or the hands of a therapist. The tool is adjustable in length so that a practitioner with varying arm length can use. The implement is adjustable in length so that it can be used on various types of therapy tables, (adjustable or fixed in height) and so that various parts of the body of a patient can be reached with the table at the same height.

The tool has assorted and exchangeable body contacting tips intended for very specific work, that is, one tip for broad pressure over a large area, efflarage, fascia, doing legs etc. Other tips are useful and effective in treating general specific areas, such as, deep bodied muscles, specific knots on a large body muscle. There tips for general specific areas, deep bodied muscles, specific knots in a large muscle, etc. Another tool is designed for a very specific pressure along the lamina groove along the spine and specific trigger points.

### BRIEF DESCRIPTION OF THE DRAWINGS

FIG. 1 shows the implement in an opened state;

FIG. 2 shows the implement in a collapsed state;

FIG. 3 is a detailed showing of how various tools can be added or removed;

FIGS. 4-6 illustrate different massage tools.

### DETAILED DESCRIPTION OF THE INVENTION

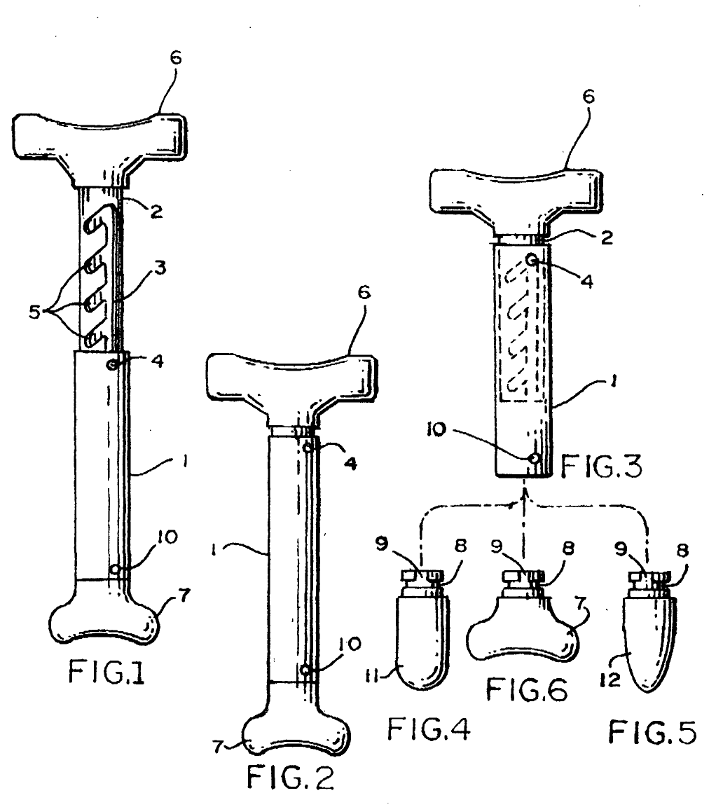

FIG. 1 shows the fully assembled massage implement 1. The implement consist of two major parts. There is a rigid metal tube 1 and a sliding insert 2 which could be made of hard rubber or a plastic material. The sliding insert has a longitudinal groove 3 therein which is held in a sliding relationship with the metal tube 1 by way of a pin or depression 4 in the bottom end of the tube 1. Along the groove 3 there are lateral exit grooves 5 which are slanted in a downward direction relative to the groove 3. The reason for this slanting is that once a certain groove has been selected, the pin or depression 4 will move into a selected lateral groove and will move in a downward direction. This way, when any downward pressure is applied to the implement, the pin or depression 4 cannot unlock itself from the longitudinal groove to thereby safely maintain a preselected position. The extending mechanism just described could be done by way of a spring-loaded peg and a series of holes. The grooves described above are preferred because they are much simpler and quicker to use.

At the top of the metal tube 1 there is provided a T shaped profile 6 made of hard rubber or plastic. In use, the therapist would place this T-shaped profile 6 in the area of the armpit to be able to provide any downward pressure to the implement as the massaging effort progresses. The T-shaped profile is fastened to the top of the metal sleeve or tube 1.

The bottom of the sliding insert has attached thereto a massaging tool 7 in a T-shaped configuration. The use of this T-configuration is accomplished by the therapist's hand covering the T-shaped configuration while guiding the tool under pressure over various tissue and muscle location. The tool 7 can be remover from the top of the metal sleeve by a twist lock mechanism 9 consisting of a circular groove 8 having an entrance 9 which is captured by a pin or depression 10 in the metal tube 1. Once the tool 7, for example, is inserted into the tube 1 and the pin 10 is captured in the circular groove, the therapist will still be able to rotate the tool as desired, while performing the massage, without losing the tool 7 or unlocking it.

FIG. 2 is an assembled and collapsed view of the massage implement. The same reference characters have been applied in this FIG. 2 as are found in FIG. 1 and no further description is deemed to be necessary because it is self-explanatory.

FIG. 3 is a more detailed depiction of the replaceable massage tools and again the same reference characters have been applied as were used in FIGS. 1 and 2.

FIG. 4 illustrates another replaceable massage tool 11 which has at its body engaging end a rounded end or a blunt end which would be used general specific areas such as deep bodied muscled or specific knots in a large muscle.

FIG. 5 shows another embodiment of a more pointed tool 12 which can be or should be used for very specific pressure application such as the lamina groove along the spine and specific trigger points.

FIG. 6 illustrates the T-shaped tool 7 including the twist locking mechanism 8 and 9.

All of the massage tips will attach and can be removed from the lower end of the metal tube or sleeve 1 by way of a twist lock type of a connection 8 and 9, as was described above, allowing the tips to be rotated to desired positions while in use.

It should be noted that the adjustable length of the implement is dictated by the lengths of the arms of the therapist, the height of the massage table and/or the body size of the patient.

It should also be noted that the fingers of the therapist are not instrumental in applying pressure to the massage implement. The fingers merely guide the tool to the impacted areas of the patient. The pressure to the body engaging massage tool is strictly applied by the upper body of the therapist.

What I claim is:

1. A body massage implement including at least basic element, a first element is a metal tube having a T-shaped profile attached thereto to be used by a therapist in the area of the armpit, the second element consists of a sliding insert 2 which is inserted into the said metal tube, means for arresting said sliding insert 2 in said metal tube at preselected positions, a bottom of said metal tube having removable and selected massaging tools attached thereto.

2. The massage implement of claim 1, wherein said sliding insert is made of a hard rubber.

3. The massage implement of claim 1, wherein said sliding insert is made of a plastic material.

4. The massage implement of claim 1, wherein said means for arresting is a longitudinal groove in said sliding insert, said longitudinal groove further having a multiple of lateral and downwardly facing grooves.

5. The massage implement of claim 1, wherein one of said removable massaging tools is of a T-shaped configuration.

6. The massage implement of claim 1, wherein another one of said removable massaging tools is a single rod having a blunt end.

7. The massage implement of claim 1, wherein another one of said removable massaging tools is a single rod having a pointed end.

8. The massage implement of claim 1 wherein said replaceable massaging tools are attached at the bottom of said sliding insert by way of a circular connection, said circular connection having an entrance slot therein for an entry of a dimple placed into said the metal of said sliding insert.
